(19) United States
(12) Patent Application Publication
(10) Pub. No.: US 2013/0097059 A1
(43) Pub. Date: Apr. 18, 2013

(54) PREDICTIVE INITIAL PUBLIC OFFERING ANALYTICS

(71) Applicants: John F. Bonner, Cham (CH); Evan T. Riles, Denver, CO (US); George P. Bonne, San Jose, CA (US); Ian Erickson, San Francisco, CA (US); Andrew Neblett, London (GB)

(72) Inventors: John F. Bonner, Cham (CH); Evan T. Riles, Denver, CO (US); George P. Bonne, San Jose, CA (US); Ian Erickson, San Francisco, CA (US); Andrew Neblett, London (GB)

(21) Appl. No.: 13/327,972

(22) Filed: Dec. 16, 2011

Related U.S. Application Data
(60) Provisional application No. 61/547,311, filed on Oct. 14, 2011.

(51) Int. Cl. G06Q 40/00

(52) U.S. Cl. 705/35

(57) ABSTRACT

Systems and techniques are disclosed for identifying a marketing opportunity by associating a set of prediction scores with a set of privately-held entities. Each of the set of prediction scores is based on a likelihood of a privately-held entity initiating an IPO over a set period of time. To derive the set of prediction scores, systems and techniques are disclosed that utilize one or more private company data, investor data, deals data, and market data associated with a privately-held entity. An accompanying confidence rating may also be provided for each of the set of prediction scores.

### CROSS-REFERENCE TO RELATED APPLICATIONS

This application claims priority to U.S. Provisional Application No. 61/547,311 filed Oct. 14, 2011, entitled ‘PREDICTIVE INITIAL PUBLIC OFFERING ANALYTICS’, the content of which is incorporated herein in its entirety.

### TECHNICAL FIELD

This disclosure relates to predictive analytics, and more particularly to predictive initial public offering analytics.

### BACKGROUND

There are many industries that market and sell products and services to private companies that are planning to initiate an Initial Public Offering (“IPO”). There are also many industries that market and sell products and services to companies that are already publicly traded. For example, investment bankers market their underwriting services to companies that plan to go public and regulatory and compliance companies market their services to companies that are already publicly traded.

Traditionally, individuals in industries that market to privately-held entities analyze different data points to estimate which companies are likely to go public. Factors considered include venture capital funding, company appearance in trade magazines and research reports, and company attendance at industry conferences. From these factors, industry experts attempt to determine the top companies that are likely go public over a set period of time.

As not all people are experts in all industries and instinctive methods may not be as accurate as computed methods, there exists a need for analytics that indicate how likely a privately-held entity is to going public in the near future. These analytics would assist with segmenting and prioritizing marketing and sales efforts and would provide unique insight into potential trends in certain industries as well as the market for IPOs.

Accordingly, there is a need for improved systems and techniques for analyzing the likelihood of IPO opportunities.

### SUMMARY

Systems and techniques are disclosed for identifying a marketing opportunity by associating a set of prediction scores with a set of privately-held entities. Each of the set of prediction scores is based on a likelihood of a privately-held entity initiating an IPO over a set period of time. To derive the set of prediction scores, systems and techniques are disclosed that utilize one or more private company data, investor data, deals data, and market data associated with a privately-held entity. An accompanying confidence rating may also be provided for each of the set of prediction scores.

Various aspects of the invention relate to identifying a marketing opportunity based on a set of predictive IPO rankings.

For example, according to one aspect, a computer-implemented method for identifying a marketing opportunity includes receiving a set of search criteria for identifying a set of privately-held entities, identifying the set of privately-held entities in response to the set of search criteria, and associating a set of prediction scores with the set of privately-held entities to generate an associated set of scores and entities, wherein the set of prediction scores and the set of privately-held entities have a one to one relationship within the associated set of scores and entities, and each predictive score of the associated set of scores and entities indicates a likelihood of initiating an initial public offering (IPO). The method also includes providing the associated set of scores and entities in response to a request, whereby, the associated set of identified privately-held entities is adaptable to be used to determine at least one marketing opportunity.

In one embodiment, the method further includes generating the set of prediction scores based on a computed funding value, profitability value, growth value, market level value, and activity value associated with each of a set of privately-held entities.

A system, as well as articles that include a machine-readable medium storing machine-readable instructions for implementing the various techniques, are disclosed. Details of various implementations are discussed in greater detail below.

Additional features and advantages will be readily apparent from the following detailed description, the accompanying drawings and the claims.

### BRIEF DESCRIPTION OF THE DRAWINGS

FIG. 1 is a schematic of an exemplary computer-based system for predicting a probability of an IPO.

FIG. 2 illustrates an example method of computing IPO analytics;

FIGS. 3-5 illustrate exemplary graphical user interfaces for use with the system of FIG. 1.

Like reference symbols in the various drawings indicate like elements.

### DETAILED DESCRIPTION

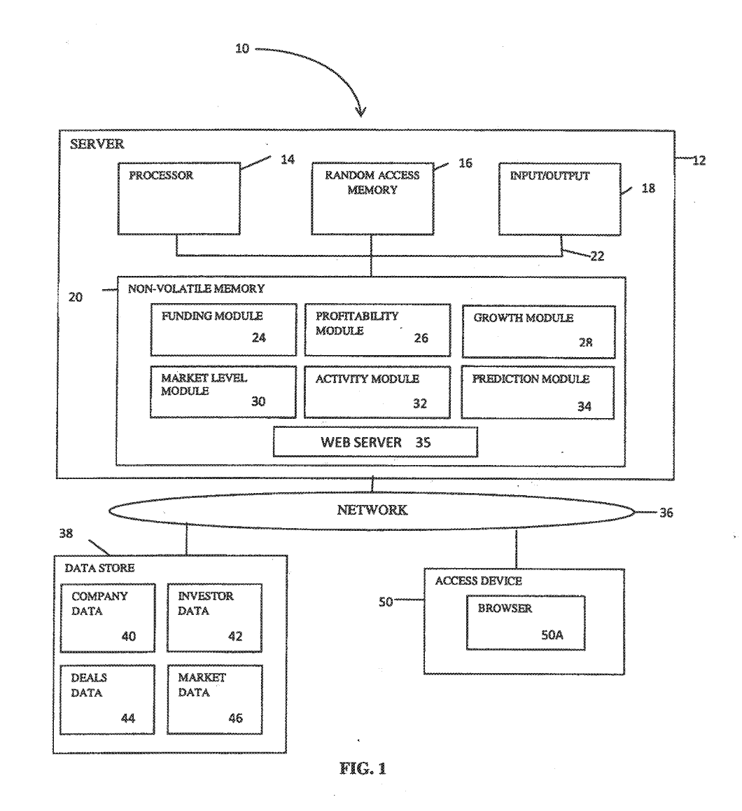

FIG. 1 shows a computer-based system that combines data inputs associated with a privately-held entity and uses those data inputs to compute a percentage probability that a privately-held entity, such as a privately-held company, will initiate an IPO over a particular time interval.

As shown in FIG. 1, in one implementation, the system 10 is configured to include an access device 50 that is in communication with a server 12 over a network 36. The access device 50 can include a personal computer, laptop computer, or other type of electronic device, such as a cellular phone or Personal Digital Assistant (PDA). In one embodiment, for example, the access device 50 is coupled to I/O devices (not shown) that include a keyboard in combination with a pointing device such as a mouse for sending web page requests to the server 12. Preferably, memory of the access device 50 is configured to include a browser 50A that is used to request and receive information from the server 12. Although only one access device 50 is shown in FIG. 1, the system can support multiple access devices.

The network 36 can include various devices such as routers, server, and switching elements connected in an Intranet, Extranet or Internet configuration. In some implementations, the network 36 uses wired communications to transfer information between the access device 50 and the server 12. In another embodiment, the network 36 employs wireless communication protocols. In yet other embodiments, the network 36 employs a combination of wired and wireless technologies.

As shown in FIG. 1, in one implementation, the server device 12 preferably includes a processor 14, such as a central processing unit (‘CPU’), random access memory (‘RAM’) 16, input-output devices 18, such as a display device (not shown) and keyboard (not shown), and non-volatile memory 20, all of which are interconnected via a common bus 22 and controlled by the processor 14. In one embodiment, as shown in the FIG. 1 example, the non-volatile memory 24 is configured to include a web server 35 for processing requests from the access device.

The web server 35 is configured to send requested web pages to the browser 50A of the access device 50 in response to receiving a request from the web browser 50A. The web server 35 communicates with the web browser 50A using one or more communication protocols, such as HTTP (Hyper Text Markup Language). In one embodiment, the web server 35 is configured to include the Java 2 Platform, Enterprise Edition (‘J2EE’) for providing a plurality of screens included in a user interface displayed on the browser 50A.

The web server 35 provides a run-time environment that accesses software modules for computing IPO prediction scores of the present invention. As shown in FIG. 1, in one embodiment, the software modules include a funding module 24, a profitability module 26, a growth module 28, a market level module 30, an activity module 32 and a prediction module 34. Details of the software modules 24, 26, 28, 30, 32 and 34 configured in the non-volatile memory 20 are discussed in further detail below.

In one embodiment, as shown in FIG. 1, a data store 38 is provided that is utilized by one or more of the software modules 24, 26, 28, 30, 32, 34 to access and store information relating to IPO analytics. In one embodiment, the data store 38 is a relational database. In another embodiment, the data store 38 is a directory server, such as a Lightweight Directory Access Protocol (‘LDAP’) server. In yet other embodiments, the data store 38 is a configured area in the non-volatile memory 20 of the server 12. Although the data store 38 shown in FIG. 1 is connected to the network 36, it will be appreciated by one skilled in the art that the data store 38 can be distributed across various servers and be accessible to the server 12 over the network 36. Alternatively, the data store 38 may be coupled directly to the server 12, or be configured in an area of non-volatile memory 20 of the server 12.

As shown in FIG. 1, in one embodiment, the data store 38 is configured to include a company data store 40, an inventor data store 42, a deals data store 44, and a market data store 46.

The company data store 40 includes data relating to companies that are captured from filings, web sites, third party data feeds, and data contributions made by companies. For example, in one embodiment, the company data store 40 includes a description of entity businesses, most recent and historical financial details (e.g., Income Statement, Balance Sheet) of entites, and industry classification(s) associated with entities.

The investor data store 42 stores details regarding entity investors that are captured from various sources, such as press releases, web sites, and investors themselves. Data stored in the investor data store 42 may include the names of entities, such as company names or firms, number of rounds of financing the entity has raised, the number of investors invested in the entity and the aggregate dollar amount invested in the entity.

The deals data store 44 stores deal information associated with entities. In one embodiment, deal information is captured from prospectuses, press releases, security exchanges and news articles. Example information stored in the deals data store 46 may include deal type (e.g., equity and/or asset deal), filing date, completion date, and dollar amount raised.

The market data store 46 stores details regarding market data captured from filings, security exchanges, and press releases. Example market data stored in the market data store 46 may include public company financials and market pricing.

It should be noted that the system 10 shown in FIG. 1 is one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a non-networked standalone configuration, data is communicated to the computing device via an input device, such as a keyboard and/or mouse, and data output of the system is communicated from the computing device to a display device, such as a computer monitor.

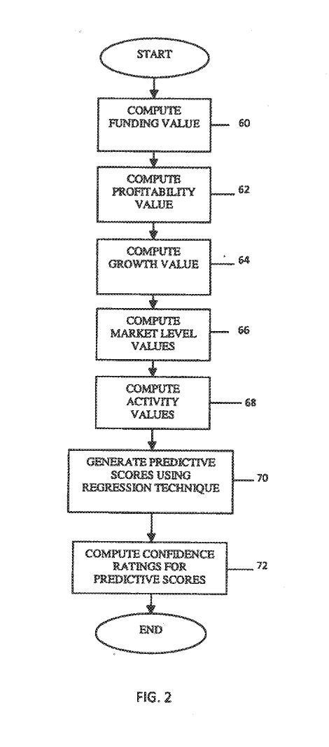

Turning now to FIG. 2, an example method of computing IPO predictive analytics for a privately-held entity is disclosed. As shown in the FIG. 2 example, first, at step 60, a funding value (e.g., component) is computed for each of a set of privately-held entities. In one embodiment, the funding module 24 computes the funding value by combining two data variables, a funding-to-sales ratio, and a funding-to-assets ratio, where funding is the total amount of venture capital and private equity funding a privately-held entity received up to a particular date, assets are the value of assets on a most recently available balance sheet associated with the entity, and sales are the most recently available annual revenue associated with the entity. In one embodiment, the funding module 24 computes the funding-to-sales ratio and the funding-to-assets ratio using information stored in the data store 38. Once the funding-to-sales ratio and funding-to-assets ratio are computed, the funding module 24 computes the funding value by combining the two ratios using a linear weighting technique after first converting each ratio into a rank via a look-up table. Various linear weighting techniques, as are known in the art, may be implemented by the funding module 24.

Next, at step 62, the profitability module 26 computes a profitability value for each of a set of privately-held entities by combining values for two variables, a profit margin (PM) ratio and a return on assets (ROA) ratio. The PM ratio is computed for each entity using a most recently available annual net income value associated with each privately-held entity divided by sales associated with each privately-held entity, respectively. In one embodiment, the ROA ratio is computed for each entity by dividing net income associated with each privately-held entity by asset values associated with each privately-held entity, respectively. The profitability module 26 then computes the profitability value by combining the two ratios, PM and ROA, using a linear weighting technique after first converting each ratio into a rank via a look-up table.

Next, at step 64, the growth module 28 computes a growth value for each of a set of privately-held entities. In one embodiment, the growth module 28 computes the growth value using a most recent year-over-year sales growth for each privately-held entity. The year-over-year sales growth may be determined by dividing sales values for the most recent year of the entity by sales of the prior year and subtracting one (1). The growth module 28 then converts the year-over-year sales growth value to a percentile rank via a look-up table to compute the growth value.

At step 66, the market level module 30 determines a value for how expensive or inexpensive public companies presently are in a given industry relative to historical industry valuation levels and also how those valuation levels have changed historically over time. Advantageously, such determinations may serve as a proxy for the relative valuation a private entity may receive and as a result, be indicative of how attractive it may be for the privately-held entity to initiate an IPO. In one embodiment, the market level module 30 evaluates the median twelve (12) month earnings/price and a median twelve (12) month sales/price ratio for all public companies in a given industry as of a particular date (e.g., current date), and then compares those ratios to historical ranges. In one embodiment, to compute the earnings/price ratio, the market level module 30 divides the current twelve (12) month earnings per share (EPS) value of a publicly traded entity by a current stock price for each publicly traded entity in a given industry, and then computes the median of those ratios at various points in time.

In one embodiment, to compute the sales/price ratio, the market level module 30 divides the current twelve (12) month revenue value of the publicly traded company by the current company market capitalization for each company in a given industry, and then computes the median of those ratios at each point in time. Next, for each computed median ratio, the market level module 30 compares and ranks the computed value relative to historical ranges to determine how expensive or inexpensive entities in a given industry are valued at a particular point in time.

Once the market level module 30 determines the relative ranks of the earnings/Price and sales/price ratios, the market level module 30 then combines the two ranks using a linear weighting technique to form a market-multiples-level rank. In one embodiment, the market level module 30 also determines by how much the median valuation ratios have changed over a period of time, such as the last twelve (12) months, which may be used to determine whether entities in an industry have increased or decreased in value over the period of time. As will be appreciated by one skilled in the art, rising valuation levels generally imply a more favorable IPO environment than falling or stagnant valuation levels

In one embodiment, the market level module 30 computes an earnings/price change value by subtracting a historical one-year industry median earnings/price ratio from a current industry median earnings/price ratio. The market level module 30 also computes a sales/price change value by subtracting a historical one-year sales/price ratio from a current industry median sales/price ratio. The market level module 30 then compares the computed sales/price change value to a historical sale/price change value and computed earnings/price change value to a historical earnings/price change value to generate a sales/price change rank and earnings/price change rank, respectively.

The market level module 30 then combines the earnings/price change rank and sales/price change rank using a linear weighting technique to create a market-multiples-change rank. Finally, the market level module 30 combines the computed market-multiples-change rank and the before-mentioned market-multiples-level rank using a linear weighting technique to form the market level value. The market level value may be the same for all companies in a given industry.

Next, at step 68, the activity module 32 computes a first value by determining the number of firms that have initiated an IPO over a set period of time, such as the last twelve (12) month period, over a same industry as associated with the privately-held entity. The activity module 32 then divides the first value by a total number of privately-held entities stored in the data store 38 for the given industry.

The activity module 32 then ranks the first variable by comparing the current value of each industry's IPO frequency with its historical range to form the activity value. Thus, the computed activity value represents the fraction of companies that have recently initiated an IPO in a given industry. Higher activity values may indicate that the IPO market is considered “hot” for an industry. The computed activity value may be the same for all companies in a given industry.

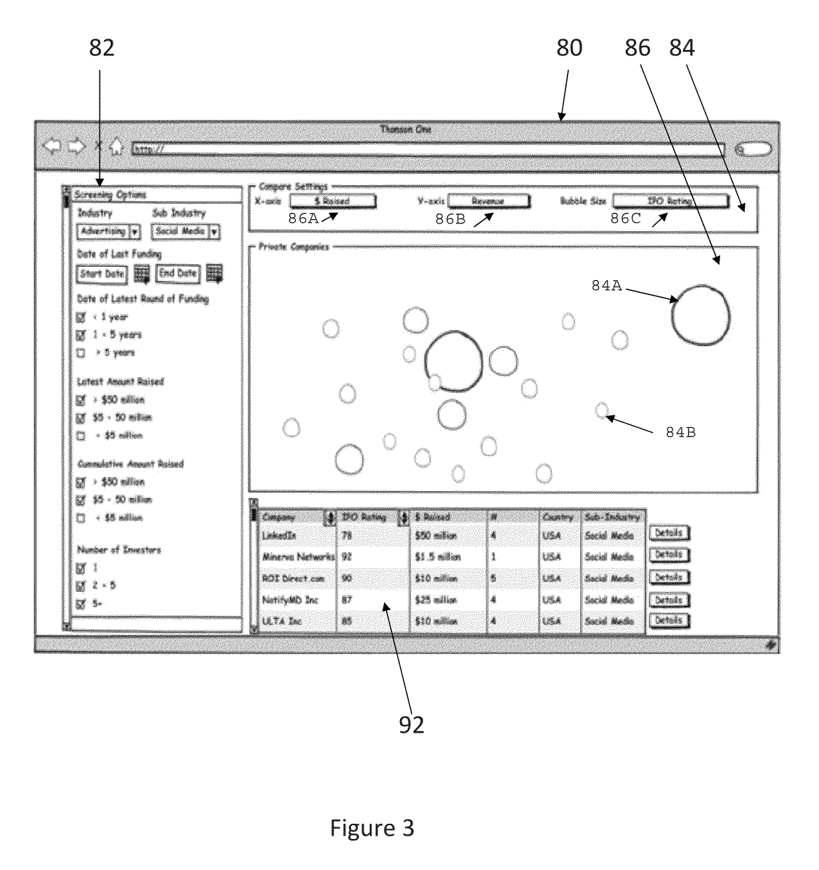

Once the profitability value, funding value, growth value, market level value, and activity value are computed by each respective software module 26, 24, 28, 30, 32, at step 70, the prediction module 34 combines these values using a logistic regression model to form an overall IPO prediction score that is then associated with a particular privately-held entity. The prediction module 34 then generates an associated set of IPO prediction scores and entities that may be provided to a user in response to a request FIGS. 3-5 illustrate example graphical user interfaces that may be utilized by users of the present system for such purposes. In one embodiment, the logistic regression formulation used by the prediction module 34 to compute a prediction score for a privately-held entity is as follows:

Z=k0+k1*funding_value+k2*profitability_value+k3*growth_value+k4*market_value+k5*activity_value

IPO_probability=1/(1+exp(−Z))

where k0, k1, k5 are constants determined by a logistic regression fit to historical data.

Advantageously, embodiments of the present invention allow for some level of missing data among the various value inputs (e.g., funding value, growth value, etc.). For example, in one embodiment, four of the five input values to the logistic regression model may be non-null in order for a privately-held entity to be scored by the prediction module 34. In one embodiment, the IPO probability values computed by the prediction module 34 are then ranked to create a 1-100 percentile scores for one or more privately-held entities. In another embodiment, the IPO probability scores are not relative IPO prediction scores but rather, absolute (e.g., raw) predicted probability values obtained from the logistic regression model.

In one embodiment, once one or more prediction scores are determined, at step 72, the prediction module 34 computes a confidence rating that is assigned to each prediction score indicating a level of uncertainty in its IPO probability value. Example confidence ratings include “High”, “Medium” and “Low”. The confidence rating is a function of both the completeness of data used in generating analytics for the entity (e.g., were calculations based on non-NULL values for every ratio or metric in every value input) as well as its timeliness (e.g., how recent are the financials used in the calculation of the growth value and profitability value). Privately-held entities with very complete and timely data receive confidence ratings of “High”.

In one embodiment, for example, the prediction module 34 implements the following method to compute a confidence rating:

For every privately-held entity evaluated by the system, the prediction module 34 initializes a variable to zero (0) indicating each entity's “uncertainty points”, then
1) The prediction module 34 adds one (1) uncertainty point if one of the components is NULL.
2) The prediction module 34 adds one (1) uncertainty point if the period end date of the financial statements used is more than 455 days in the past.
3) The prediction module sums up the uncertainty points for each privately-held entity.

In one embodiment, the prediction module 34 assigns a confidence rating of “Low” for every privately-held entity associated with two (2) or more uncertainty points. The prediction module 34 assigns a confidence rating of “Medium” for every privately-held entity company associated with one (1) uncertainty point, and assigns a confidence rating of “High” for every privately-held entity associated with zero (0) uncertainty points.

Referring now to FIG. 3, an example graphical user interface (GUI) 80 provided by the prediction module 34 is disclosed. The GUI 80 may be used to display marketing opportunities associated with privately-held entities. For example, GUI 80 may be used by a user for purposes of pitching a deal and desiring to know what privately-held entities (e.g., companies or firms) have a high likelihood of initiating an IPO.

As shown in the FIG. 3 example, in one embodiment, the GUI 80 includes a plurality of selectable screening options 82 for specifying a set of search criteria, a display area 84 for visually depicting representations of privately-held entities that meet the set of search criteria, and a detail area 88 for displaying privately-held entity and associated prediction score information.

The set of search criteria may be based on one or more options included in the selectable screening options 82. In one embodiment, as shown in FIG. 3, the selectable screening options 82 include an industry and sub-industry pull-down menu for specifying an industry and sub-industry in which privately-held entities are to be selected from for analysis, calendar functions for specifying a start date and end date of a privately-held entity's last funding activity, and a plurality of check boxes for specifying a range of values associated with a latest and cumulative funding amount obtained by privately-held entities, and total number of investors invested in each privately-held entity.

The display area 84 graphically depicts representations of privately-held entities that have been identified by the prediction module 34 based on the set of search criteria selected. As shown in the FIG. 3 example, in one embodiment, privately-held entities are depicted using circular shapes, such as bubbles, on a graph included in the display area 84. Of course, it will be appreciated by one skilled in the art that depiction of the identified privately-held entities is not limited to circular shapes and various other types of shapes may be utilized to depict identified entities in the display area 84.

The display control area 86 establishes settings for the display of identified entities in the display area 84. For example, in one embodiment, as shown in FIG. 3, the display control area 86 includes an x-axis control 86A that allows a user to specify units of measurement for plotting entities along a horizontal axis of the display area 84, and a y-axis control 86B that allows a user to specify units of measurement for plotting entities along a vertical axis of the display area 84. Using the x-axis control 86A and y-axis control 86B settings, the prediction module 34 plots identified entities in the display area 84 using the specified units of measurement in a coordinate system. The display control area 86 also includes a bubble size control 86C that allows the user to specify shape size of identified entities displayed in the display area 84. For example, as shown in FIG. 3, the bubble size control 86C indicates that the IPO prediction score, identified in FIG. 3 as the “IPO Rating”, is to be used to determine the diameter of entity representations depicted in the display area 84. In one embodiment, during operation of the system, a user may hover over a large bubble 84A and/or small bubble 84B using a pointing device, such as a mouse, to view entity name, entity revenue and associated entity prediction score. Larger bubbles indicate greater entity prediction scores and smaller bubbles indicate lower prediction scores associated with identified privately-held entities.

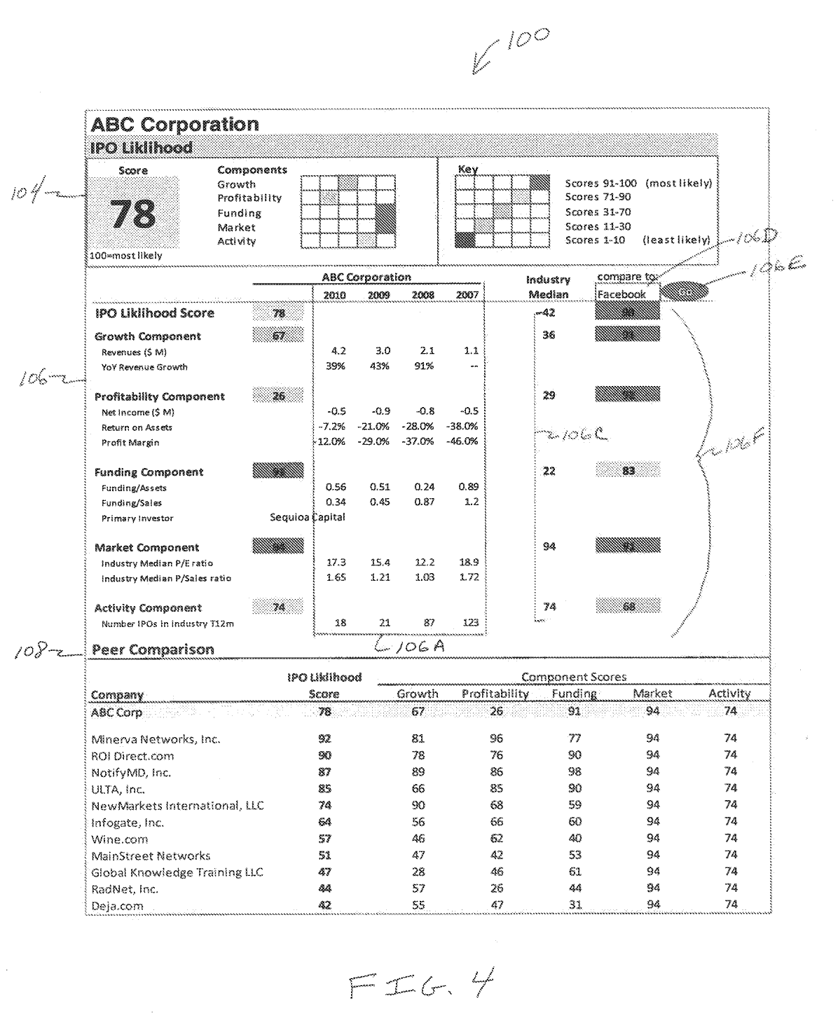

The detail area 88 is a user-selectable area that displays details of identified entities. In one embodiment, as shown in FIG. 3, the detail area 88 displays an identified entity name, attributes associated with the entity that meet specified search criteria, and an associated prediction score 92. As shown in the FIG. 3 example, in one embodiment, the detail area 88 may display identified entities in a tabular fashion and associate with each identified entity a details button 90 that upon selection, displays price/earnings information for the entity. Upon selection of an associated IPO prediction score 92 from the detail area 88, the prediction module 34 provides an entity analysis interface 100 as shown in FIG. 4.

Turning now to FIG. 4, in one embodiment, the entity analysis interface 100 provides various IPO analytics that are associated with privately-held entities. As shown in FIG. 4, the entity analysis interface 100 includes an IPO headline portion 104, an IPO analytic portion 106, and a peer comparison portion 108.

The IPO headline portion 104 shows the overall IPO prediction score associated with the privately-held entity as well as component scores determined for the privately-held entity. As shown in the FIG. 4 example, in one embodiment, the IPO headline portion 104 includes a legend key to aid in interpreting prediction and component scores. In one embodiment, scores closer to one-hundred (100) indicate that a privately-held entity is more likely to initiate an IPO and scores closer to one (1) indicate that a privately-held entity is less likely to initiate an IPO.

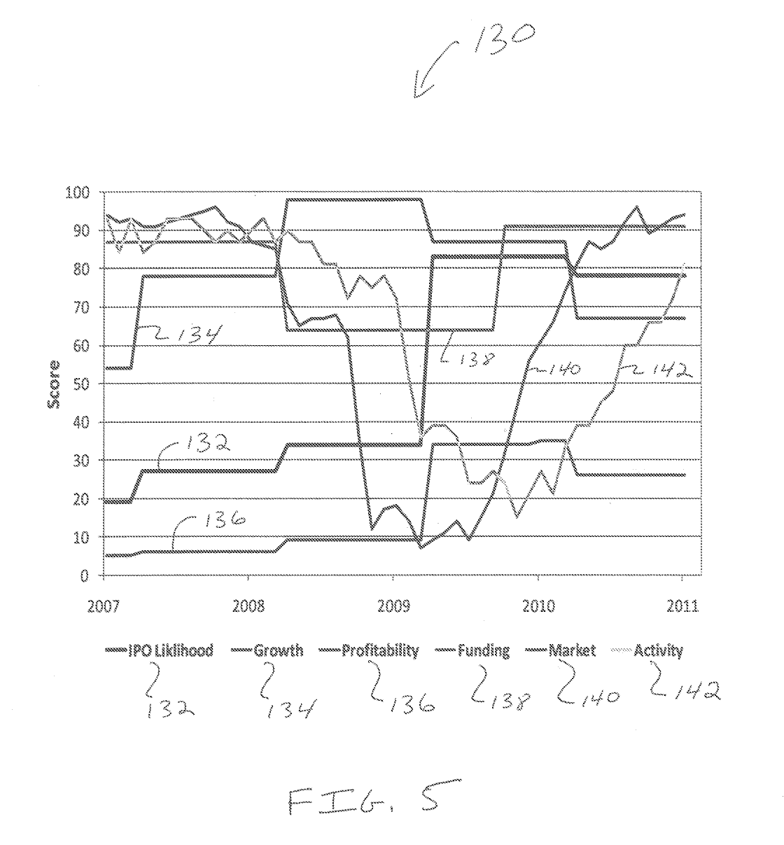

The IPO analytics portion 106 displays a breakdown of component analytics associated with an entity. For example, as shown in FIG. 4, component analytics include a growth component, profitability component, funding component, market component, and activity component, all of which are combined, as described previously, to compute the overall JPO prediction score. As shown in FIGS. 4 and 5, the phrase “Growth Component”, “Profitability Component”, “Funding Component”, “Market Component”, and “Activity Component” refer to the growth value, profitability value, funding value, market level value, and activity value, respectively, discussed in connection with FIGS. 1 and 2. In one embodiment, as shown in FIG. 4, multiple years 106A of raw data points driving computation of component scores also may be provided.

Further, turning now to FIG. 5, a historical view 130 of prediction and component scores provided by the system is shown. As shown in the FIG. 5 example, in one embodiment, the historical view 130 includes an overall IPO prediction score 132 and associated component scores 134, 136, 138, 140, 142 that may be graphically displayed showing multiple time intervals in response to a request.

Referring back to FIG. 4, in one embodiment, one or more of the raw data points 106B may be entered and/or modified thus allowing a user to enter/update raw data directly. Advantageously, analytics of the present invention may then be computed based on such new/modified data.

As shown in the FIG. 4 example, in one embodiment, the system may also display an industry median score 106C for each analytic component for comparison purposes. Of course, it will be appreciated by one skilled in the art that the system of the present invention may automatically compare component analytics with industry median analytics and provide results based on such a comparison.

The entity analysis interface 100 also provides on-demand comparison functionality. For example, as shown in FIG. 4, a data entry field 106D is provided for specifying an entity identifier, such as an entity name. Upon selection of a “Go” button 106E, in one embodiment, the system displays an IPO prediction score and component scores 106F associated with the specified entity which may advantageously be used in further comparisons.

The peer comparison portion 108 of the entity analytics interface 100 identifies additional entities that are considered peer entities to the privately-held entity selected from the detail area 88 of the graphical user interface 80. As shown in the FIG. 4 example, the peer comparison portion 108 may display a set of peer entities with associated prediction scores and component scores. In one embodiment, entities displayed in the peer comparison portion 108 are identified based on an industry identifier associated with each of the set of peer entities. Further, one or more entity name displayed in the set of peer entities may be a hyperlink. Upon selection of a hyperlink, the prediction module 34 provides a second entity analysis interface illustrating IPO analytics associated with the entity identified by the hyperlink.

Various features of the system may be implemented in hardware, software, or a combination of hardware and software. For example, some features of the system may be implemented in one or more computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

What is claimed is:

1. A computer-implemented method for identifying a marketing opportunity comprising:
receiving a set of search criteria for identifying a set of privately-held entities;
identifying the set of privately-held entities in response to the set of search criteria;
associating a set of prediction scores with the set of privately-held entities to generate an associated set of scores and entities, the set of prediction scores and the set of privately-held entities having a one to one relationship within the associated set of scores and entities, wherein each predictive score of the associated set of scores and entities indicates a likelihood of initiating an initial public offering (IPO); and
providing the associated set of scores and entities in response to a request, whereby, the set of identified privately-held entities is adaptable to be used to determine at least one marketing opportunity.

2. The method of claim 1, further comprising generating the set of predictions scores based on a funding value, a profitability value, a growth value, a market level value, and an activity value associated with each privately-held entity of the set of privately-held entities.

3. The method of claim 2, further comprising computing the funding value for each of the set of privately-held entities based on at least a funding-to-sales ratio and a funding-to-assets ratio associated with each privately-held entity in the set of privately-held entities.

4. The method of claim 3, further comprising:
converting the funding-to-sales ratio to a funding-to-sales percentile rank and the funding-to-assets ratio to a funding-to-assets percentile rank; and
combining the funding-to-sales percentile rank with the funding-to-assets percentile rank using a linear weighting algorithm.

5. The method of claim 4, comprising:
summing a total amount of venture capital and private equity funding received by each privately-held entity over a first time interval; and
dividing the total amount by a revenue value associated with each privately-held entity to form the funding-to-sales ratio for each privately-held entity of the set of privately-held entities.

6. The method of claim 4, comprising:
summing a total amount of venture capital and private equity funding received by each privately-held entity over a first time interval; and
dividing the total amount by a value of assets associated with the privately held entity to form the funding-to-assets ratio for each privately-held entity of the set of privately-held entities.

7. The method of claim 2, further comprising computing the profitability value for each of the set of privately-held entities based on at least a profit-margin ratio and a return-on-assets ratio associated with each privately-held entity of the set of privately-held entities.

8. The method of claim 7, comprising:
converting the profit-margin ratio to a profit-margin percentile rank and the return-on-assets ratio to a return-on-assets percentile rank; and
combining the profit-margin percentile rank with the return-on-assets percentile rank using a linear weighting algorithm.

9. The method of claim 8, comprising:
determining a net income value associated with each privately-held entity over a time interval; and
dividing the net income value by a sales value associated with each privately-held entity to form the profit margin ratio for each of the privately-held entities.

10. The method of claim 8, comprising:
determining a set of net income values over a time interval, the set of net income values having a one-to-one relationship with the set of privately-held entities and a set of asset values; and
dividing the set of net income values by a respective entry in the set of asset values to form the return-on-assets ratio for each privately-held entity in the set of privately-held entities.

11. The method of claim 2, further comprising computing the growth value based on a sales growth ratio associated with each of the privately-held entities.

12. The method of claim 11, comprising:
dividing a first sales value associated with one of the set of privately-held entities and a first time interval by a second sales value associated with the one of set of the privately-held entities and a second time interval to form the sales growth ratio, the second time interval prior to the first time interval;
subtracting one (1) from the sales growth ratio to form a second sales growth ratio; and
computing the growth value for the one of the set of privately-held entities by converting the second sales growth ratio to a percentile rank.

13. The method of claim 2, further comprising computing the market level value for each of the set of privately-held entities based on a median earnings/price ratio and a median sales/price ratio associated with publicly-held entities in an industry in common with each of the set of privately-held entities.

14. The method of claim 13, further comprising:
converting the median earnings/price ratio to a earnings/price percentile rank and the median sales/price ratio to a sales/price percentile rank;
combining the earnings/price percentile rank and the sales/price percentile rank using a linear weighting algorithm.

15. The method of claim 12, further comprising:
comparing the median earnings/price ratio to a historical earnings/price ratio and the median sales/price ratio to a historical sales/price ratio for the industry to generate a comparison; and
converting the median earnings/price ratio to the earnings percentile rank and the median sales/price ratio to the sales/price percentile rank using the comparison.

16. The method of claim 2, further comprising computing the activity value for each privately-held entity of the set of privately-held entities based on a number of entities having initiated an IPO over a first time interval in a same industry as each privately-held entity of the set of privately-held entities.

17. The method of claim 16, comprising:
computing a first value indicative of the number of entities having initiated the IPO over the first time interval;
dividing the first value by a number of privately-held entities associated with the same industry to form a second value; and
converting the second value to a percentile rank to form the activity value.

18. The method of claim 2, further comprising using the funding value, the profitability value, the growth value, the market level value, and the activity value in a logistic regression model to generate each predictive score.

19. The method of claim 18, further comprising associating a confidence rating to each predictive score, the confidence rating indicative of completeness or timeliness of information used to determine the funding value, the profitability value, the growth value, the market level value, and the activity value.

20. A computer-implemented device adapted to identify a marketing opportunity comprising:
means for identifying a set of privately-held entities responsive to a set of search criteria;
means for associating one of a set of prediction scores to each of the set of privately-held entities, each predictive score indicating a likelihood of the associated privately-held entity initiating an initial public offering (IPO); and
means, responsive to a request, for providing the associated set of identified privately-held entities in response to the request,
whereby, the associated set of identified privately-held entities is adaptable to be used to determine at least one marketing opportunity.

21. The system of claim 20, further comprising means for generating the set of prediction scores based on a funding value, a profitability value, a growth value, a market level value, and an activity value associated with each of the set of privately-held entities.

22. A computing device comprising:
a processor;
a memory operatively coupled to the processor, the memory storing instructions that, in response to receiving a request, cause the processor to:
identify a set of privately-held entities in response to receiving a set of search criteria;
associate a set of prediction scores with the set of privately-held entities to generate an associated set of scores and entities, the set of prediction scores and the set of privately-held entities having a one to one relationship within the associated set of scores and entities, wherein each predictive score of the associated set of scores and entities indicates a likelihood of initiating an initial public offering (IPO);
generate a signal associated with the associated set of scores and entities in response to the request, whereby, the associated set of identified privately-held entities is adaptable to be used to determine at least one marketing opportunity; and
transmit the signal.

23. An article comprising a machine-readable medium storing machine-readable instructions that, when applied to the machine, cause the machine to:
identify a set of privately-held entities in response to receiving a set of search criteria;
associate a set of prediction scores with the set of privately-held entities to generate an associated set of scores and entities, the set of prediction scores and the set of privately-held entities having a one to one relationship within the associated set of scores and entities, wherein each predictive score of the associated set of scores and entities indicates a likelihood of initiating an initial public offering (IPO);
generate a signal associated with the associated set of scores and entities in response to the request, whereby, the associated set of identified privately-held entities is adaptable to be used to determine at least one marketing opportunity; and
transmit the signal.
